(19) United States
(12) Patent Application Publication
(10) Pub. No.: US 2013/0129594 A1
(43) Pub. Date: May 23, 2013

(54) PROCESS FOR MANUFACTURING A NANOMETRIC CAGE AND ASSOCIATED CAGE

(71) Applicants: Luigi Genovese, Grenoble (FR); Pascal Pochet, La Murette (FR)

(72) Inventors: Luigi Genovese, Grenoble (FR); Pascal Pochet, La Murette (FR)

(21) Appl. No.: 13/511,432

(22) PCT Filed: Nov. 22, 2010
(86) PCT No.: PCT/FR2010/052579

§ 371 Date: Sep. 5, 2012

(30) Foreign Application Priority Data
Nov. 24, 2009 (FR) 0958327

(51) Int. Cl. C01B 31/02

(52) U.S. Cl. CPC C01B 31/0293; Y10S 977/734; Y10S 977/848; B82Y 40/00
USPC 423/290; 423/345; 423/409; 423/412; 423/622; 427/282; 216/66; 216/83; 977/734; 977/848

(57) ABSTRACT

A method for manufacturing a nanoscale cage of a material suitable for forming a molecular layer, including a step of shaping and packaging an object in the general shape of a revolving cylinder, the shaping and packaging step being adapted according to the position of the value of the diameter of the revolving cylinder relative to a threshold below which a folding of the ends of the cylinder is promoted.

### PRIORITY CLAIM

This application is a nationalization under 35 U.S.C. §371 of PCT Application No. PCT/FR2010/052479, filed Nov. 22, 2010, which claims priority to French Patent Application No. 0958327, filed Nov. 24, 2009, and is incorporated by reference herein.

### TECHNICAL FIELD

The invention relates to a process for manufacturing a nanometric cage of a material able to form a molecular sheet, for example silicon carbide (SiC), and an associated cage.

By “nanometric object” is meant an object of which at least one dimension is of an order of magnitude smaller than a micron. By “cage” is meant a cluster of atoms in which all the chemical bonds are on a surface of which at least one direction is periodic and of which all the dimensions are nanometric.

### BACKGROUND

The exceptional physical and mechanical properties of silicon carbide make it one of the most promising materials for the emerging fields of microelectronics and catalysis, in particular. It is generally considered that silicon carbide is more resistant than carbon to high temperatures and to mechanical stresses.

Silicon carbide has valency properties comparable to those of carbon, owing to the fact that silicon is in the same column of the periodic table as carbon, and that both of these atoms are able to adopt sp² hybridization or sp³ hybridization and form corresponding bonds with their neighbours.

With reference to FIG. 1, it will be recalled that carbon exists in the forms of diamond and graphite which are three-dimensional (3D, bottom right in FIG. 1), graphene which is two-dimensional (2D, top part of FIG. 1), nanotube which is one-dimensional (1D, tube of nanometric size, bottom centre in FIG. 1) and fullerene which is zero-dimensional (0D, nanometric cage, bottom left in FIG. 1).

SiC structures in cage form or in tubular shapes are in particular of interest primarily on account of their potential electronic properties.

Multi-wall SiC nanotubes with large inter-wall spacing have been characterized. The wide inter-wall spacing observed is characteristic of a bond of the sp² type within each wall, which demonstrates the stability of SiC in the sp² form and therefore opens the route to synthesis of single-wall nanotubes.

As with carbon nanotubes, the orientation of the folding of the sheets with hexagonal lattices leads either to the zigzag shape, i.e. the axis of the cylinder is parallel to two opposite sides of the hexagons, or to a shape of the armchair type, i.e. the axis of the cylinder is perpendicular to two opposite sides of the hexagons.

In experiments it has also been possible to replace 5% of the carbon atoms of a fullerene with silicon atoms, but no more, which means that we do not know how to obtain nanometric cages of stoichiometric silicon carbide or with stoichiometry close to a 1:1 ratio (by which we mean for example between 25 and 75% of silicon or between 30 and 60 or 45 and 55%, the percentages being expressed in number of atoms).

In particular there is no structure equivalent to the carbon C60 fullerene, but with half of the atoms substituted with silicon atoms, as shown in FIG. 2 (where carbon atoms are designated C and silicon atoms Si). In a diatomic material like silicon carbide, rings with an even number of vertices are preferred.

We do not yet have nanometric cages of stoichiometric or near-stoichiometric silicon carbide in a form offering useful properties under exacting conditions.

Cages of other materials able to form a molecular sheet, in particular of diatomic materials (by diatomic material is meant a material comprising a network in which two atomic species are present in proportions which may or may not be stoichiometric), are also of considerable industrial interest. These are for example cages of boron nitride BN, aluminium nitride AlN, gallium nitride GaN and zinc oxide ZnO. In the particular case of aluminium nitride, the article by Hou et al., Physica E, 27, 2005, 45, discusses the ionization potential of the end of semi-infinite nanotubes. Monatomic materials, such as boron, that are able to form a molecular sheet, are also intended in the context of the invention.

### DETAILED DESCRIPTION

The invention proposes in this context a process for manufacturing a nanometric cage of a material able to form a molecular sheet, comprising a step of formation and conditioning of an object whose general shape is that of a cylinder of revolution, the step of formation and conditioning being adapted in relation to the position of the value of the diameter of the cylinder of revolution relative to a threshold below which folding of the ends of the cylinder is favoured.

Based on this process, a method is provided for manufacturing nanometric cages in a form offering useful properties under exacting conditions.

According to an advantageous feature, the process comprises a step of formation of an object comprising a sheet, said object being suitable for forming, optionally via topological folding, an object whose general shape is that of a cylinder of revolution having a diameter below or alternatively above a threshold below which a reaction of folding of the ends of the cylinder is favoured.

According to an advantageous feature, as said object is suitable for forming a cylinder of revolution via topological folding, the process further comprises a step of thermodynamic activation promoting said topological folding.

According to an advantageous feature, the object comprising a sheet is a nanotube, preferably of “armchair” configuration or of “zigzag” configuration, for example single-wall or multi-wall with wide inter-wall spacing.

According to an advantageous feature, the object having a sheet is a cut element obtained from a sheet.

According to an advantageous feature, said object develops by formation of at least one smoothed polygon from pendant bonds on one of its edges, for example by formation of a polygon with an even, or alternatively odd, number of vertices.

According to an advantageous feature, formation of the object comprises a step of cutting the sheet into at least one cut element and for example cutting comprises a step of ion bombardment or a step of lithography, optionally combined.

According to an advantageous feature, the step of formation and conditioning further comprises a step of placement, on an edge of the object, of an element suitable for causing charge transfer with the cage. This feature is advantageous because it makes it possible to reduce the reactivity of the cage, thus increasing the possible applications.

According to an advantageous feature, the step of formation and conditioning further comprises a step of grafting, on an edge of the object, an element suitable for constraining said edge geometrically, for example a flange. This feature is advantageous because it makes it possible to reduce the reactivity of the cage, thus increasing the possible applications.

In an embodiment, the threshold is equal to 3±2 nm for stoichiometric silicon carbide, the cylinder being of “armchair” configuration.

According to an advantageous feature, the cylinder of revolution has a suitable ratio of diameter to length to minimize the energy per atom of the structure.

According to an advantageous feature, with said cylinder of revolution possessing a stability in a shape different from the shape with minimum energy, the process further comprises a subsequent step of activation, for example thermal activation, promoting development of said cylinder of revolution towards the shape with minimum energy.

For example, the material able to form a molecular sheet is silicon carbide, boron nitride, gallium nitride, aluminium nitride, zinc oxide or boron, and for example stoichiometric or near-stoichiometric silicon carbide or stoichiometric or near-stoichiometric boron nitride.

According to an advantageous feature, the material able to form a molecular sheet is boron used directly in nanotube form.

The invention also relates to the cages obtained by the process thus defined.

According to another general definition of the invention, the latter relates to a nanometric cage of a material able to form a molecular sheet, comprising an object whose general shape is that of a cylinder of revolution, the shape and conditioning of which are adapted as a function of the position of the value of the diameter of the cylinder of revolution relative to a threshold below which folding of the ends of the cylinder is favoured.

According to an advantageous feature, the nanometric cage consists of a cylinder of revolution of diameter below, or alternatively above, a threshold below which folding of the ends of the cylinder is favoured.

In another embodiment the nanometric cage consists of a cylinder of revolution of diameter below a threshold above which folding of the ends of the cylinder is favoured. Its folding is zigzag, armchair or chiral. Its two ends are identical or different.

According to an advantageous feature, the cage is composed of a cylinder of revolution having a ratio of diameter to length suitable for minimizing the energy per atom of the structure.

According to an advantageous feature, the material is silicon carbide, boron nitride, gallium nitride, aluminium nitride, zinc oxide or boron, for example stoichiometric or near-stoichiometric silicon carbide or boron nitride.

The invention also proposes an element of molecular sheet suitable for forming, optionally via topological folding, a cylinder of revolution having a diameter below a threshold below which folding of the ends of the cylinder is favoured.

### BRIEF DESCRIPTION OF THE DRAWING

The invention will now be described in detail, with reference to the attached drawings.

FIG. 1 shows carbon structures of various dimensions.

FIG. 2 shows a silicon carbide structure similar with respect to its geometry to a carbon fullerene.

FIG. 3 shows an embodiment of a process according to the invention.

FIGS. 4 and 5 show aspects of embodiments of a process according to the invention.

FIG. 6 shows a silicon carbide structure according to the invention.

FIGS. 7 to 10 show silicon carbide structures.

FIG. 11 shows energies as a function of the diameter of different stoichiometric structures of silicon carbide, referred to the number of carbon atoms (which is also the number of silicon atoms), as well as curves relating to modelling of these energies.

FIGS. 12 and 13 show energies of different stoichiometric structures of silicon carbide and of boron nitride, respectively, as well as of curves relating to the modelling of these energies.

FIGS. 14 and 15 show two aspects employed in certain variants of a process according to the invention.

FIGS. 16 and 17 also show two other aspects employed in certain variants of a process according to the invention.

FIGS. 18 to 23 show three boron cages according to the invention.

FIGS. 24 and 25 show two cages of zigzag geometry, according to an embodiment of the invention.

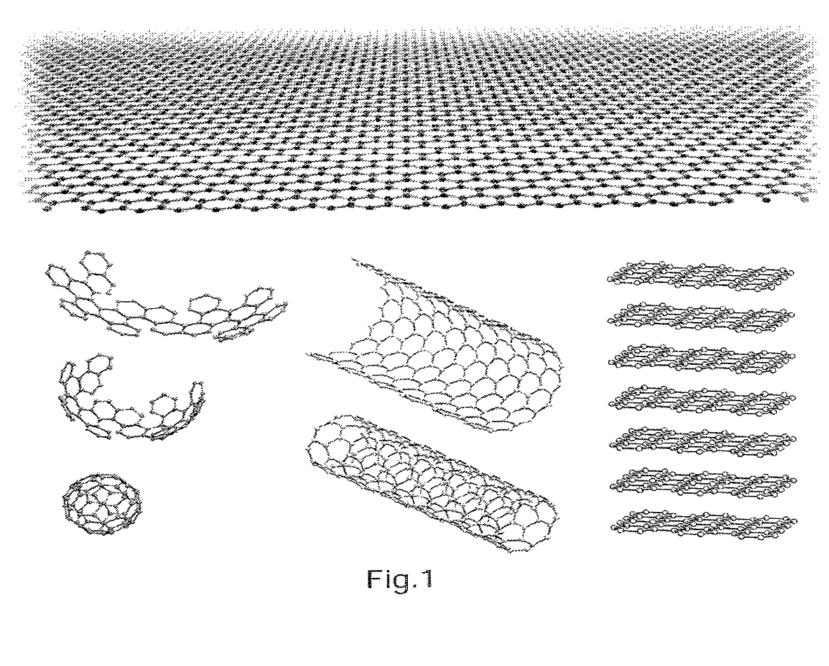

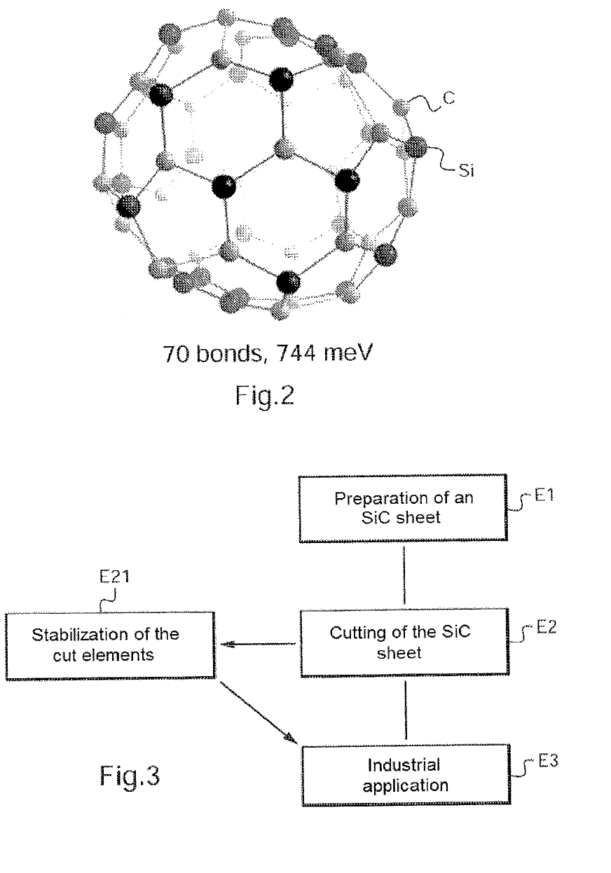

### DETAILED DESCRIPTION

With reference to FIG. 3, first a molecular sheet is prepared, here of silicon carbide, which can be flat or curved, with or without a periodic dimension, during a step E1.

During a step E2, the molecular sheet, here of silicon carbide, is cut according to suitable dimensions into cut elements.

During a step E3, the cut elements, having developed to their energy minima, are used industrially.

According to a variant, a step E21 of stabilization of the cut elements is also included, after the cutting step, or simultaneously with the latter.

The set of steps E1, E2, E3 and E21 constitutes a step of formation and conditioning of a nanometric cage.

Details of carrying out the steps thus defined will now be presented. Two general routes are presented, the first using a cylindrical nanotube, and the second a sheet without a periodic dimension.

Regarding step E2, according to a first embodiment, one or more, preferably stoichiometric, silicon carbide nanotubes are used, produced according to a previous step E1. The nanotubes can be arranged in bundles, and the nanotube bundles are lined up. This or these nanotubes are cut out by ion bombardment (with a focused ion beam) for cutting each nanotube into slices.

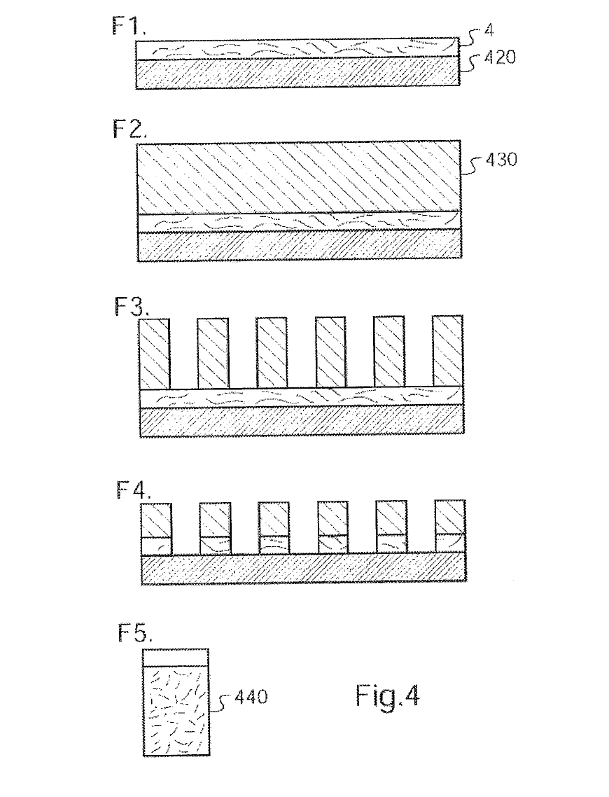

According to a variant, with reference to FIG. 4, a lithographic treatment of silicon carbide nanotubes is carried out, in order to obtain nanotubes of various lengths. The process begins with spreading nanotubes 410 on the surface of a solid substrate 420, such as a standard silicon wafer (step F1). The nanotubes 410 are then covered with a photosensitive polymer 430 (step F2), deposited for example in the form of parallel lines by spin coating or dip coating, using a mask in certain variants. The lines are preferably perpendicular to the axis of the nanotubes.

Light appropriate to the resin is applied and a photochemical reaction destroys the resin that is exposed. A proportion of the population of nanotubes is then exposed on the substrate (step F3).

Dry etching, for example by plasma, by ion bombardment or by another technique, is applied on the exposed portions of nanotubes causing cutting thereof (step F4). The ends of nanotubes exposed at the level of the cutting planes, i.e. the surfaces of the mixture to which etching was applied, made bare by the etching, are subjected in certain variants to chemical modifications of functionalization, i.e. grafting by at least one covalent or weaker bond of a chemical group having a function of electrostatic stabilization or of geometric spacing for example or a particular reactivity such as a photosensitive molecule. Finally, the resin residue is washed away and the cut nanotube elements 440 are resuspended (step F5). The functionalization, and the final formulation and presentation, for example in solution or in gas phase, constitute a conditioning process of the nanometric structure. Alternatively, wet etching is used instead of dry etching. The lithography route includes etching.

According to a second embodiment, a graphene sheet of SiC is produced. By this, we mean a molecular sheet of silicon carbide of flat structure. This object being a sheet, the atoms have hybridization of the sp² type.

Production of this sheet can be carried out for example by treating a wafer (wafer being the English term normally used in industry, equivalent to the French term “tranche”, less commonly used) of SiC at high temperature, or by high-temperature CVD (chemical vapour deposition) of carbon-containing molecules and of silylated molecules such as of ethylene and of silane, respectively, on a surface with <111> crystal geometry of a metal (iridium Ir, nickel Ni, ruthenium Ru, or platinum Pt, for example).

Advantageously, a surface with a hexagonal pattern is used, for example that of a crystal lattice of <111> geometry—face-centred cubic, compatible, in particular with respect to its lattice parameter, with the epitaxial growth of an SiC graphene sheet.

It is possible to use a single gas containing Si and C or a carbon-containing gas (for example ethylene C₂H₄) and a gas containing silicon (for example silane SiH₄), which makes it possible to vary the rates of deposition of the two elements independently of one another.

Employing these techniques on a metallic substrate, oriented <111> to promote the hexagonal pattern, a monolayer of SiC graphene is produced. Alternatively, a sheet of carbon graphene is used, in which silicon atoms are substituted. According to a variant, layers of Si are grown epitaxially on a sheet of graphene or else by transferring a sheet of graphene onto SiO₂, then the graphene is reacted with the silicon to obtain SiC graphene.

Optionally, at least a portion of this SiC graphene sheet is transferred onto a flexible substrate for subsequent use. In certain embodiments the flexible substrate is deformed so as to promote transfer. In a variant, the flexible substrate is deformed to promote topological folding of the cut element.

The sheet is then cut into templates, which can be rectangles or parallelograms of suitable size, topological folding of which leads to the formation, spontaneous or thermodynamically activated, of a cage of SiC.

First a slice of the nanotube is formed, which in an embodiment is a nanotube of stoichiometric silicon carbide the atoms of which alternate and the hexagonal network is of “armchair” configuration.

For this, rebonding of two opposite sides of the rectangle is promoted. It is to be noted that in these materials, the thermodynamics and kinetics of the bonding reaction are favourable, in particular owing to the presence of pendant bonds, if the geometry allows the atoms to approach one another in space. Then the reaction E3 of development to minimum energy as mentioned above is allowed to take place, and the latter can be very rapid, or even, under the conditions of observation, instantaneous. In an alternative embodiment, the two steps are reversed or are merged.

In an embodiment, the topological folding reaction can be assisted by temperature or pressure to overcome an energy barrier. In a variant, curvature imparted to the film once it has been transferred onto the flexible substrate is used for promoting folding of the rectangles or parallelograms. In another variant, advantage is taken of the difference in coefficient of thermal expansion between the SiC graphene sheet and the metal, which leads to the creation of folds, etching of these folds promoting the reaction of folding of the rectangles owing to their curvature.

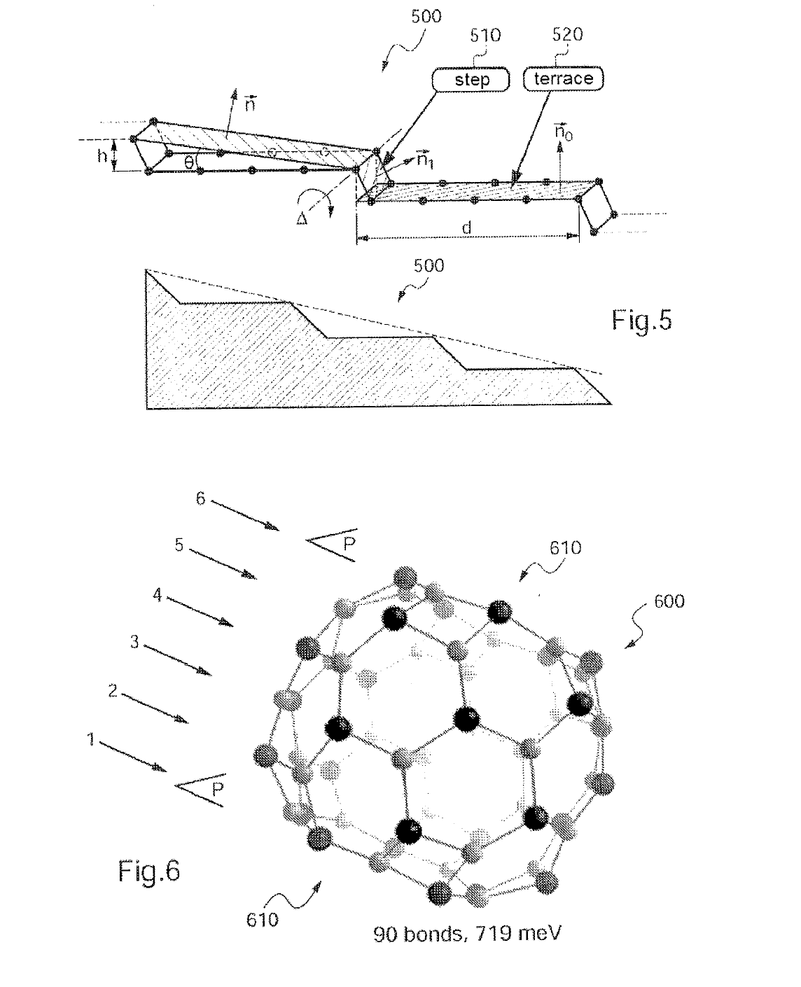

In another variant, with reference to FIG. 5, a substrate is used that has surface defects, for example steps of a vicinal face 500, which then offers favourable sites for folding the rectangles or parallelograms. Such a vicinal face 500 is shown, obtained by cutting a crystal in a direction close to an orientation of high symmetry, and comprising a series of steps 510 connecting terraces 520.

According to another variant, an SiC graphene sheet is deposited on a metallic support, then a heat source is applied, utilizing the difference in expansion coefficient between the sheet and the metal to create folds, which are hot-etched or are subjected to a stabilization process.

According to another variant, the SiC graphene is deposited using a mask, certain masking-related dimensions of which are nanometric, and masking a metal on which Si and C are deposited in the bare zones. The SiC deposited is therefore directly in the form of rectangles or parallelograms of desired size, which makes it possible to obtain a patterned SiC graphene sheet directly, i.e. having a geometric pattern in its plane, certain dimensions of which are nanometric.

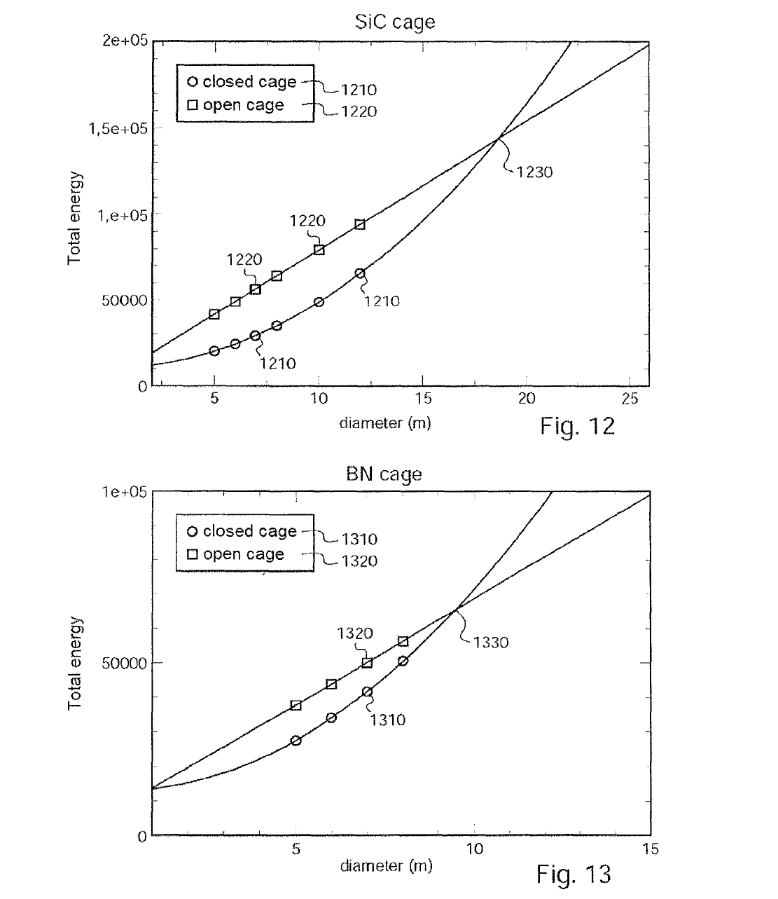

In the embodiment described, a nanometric dimension of the mask is selected so as to obtain the technical effect of folding presented with reference to FIGS. 12 and 13. For this, the mask pattern is selected so as to permit the formation of rectangles whose side which, via folding giving an armchair configuration, defines the diameter of a tube, has a length below the threshold referred to in FIGS. 12 and 13.

Next, the mask is removed and then folding is promoted while the rectangles are on the metallic substrate. According to a variant, folding is promoted after transferring the rectangles onto a flexible substrate.

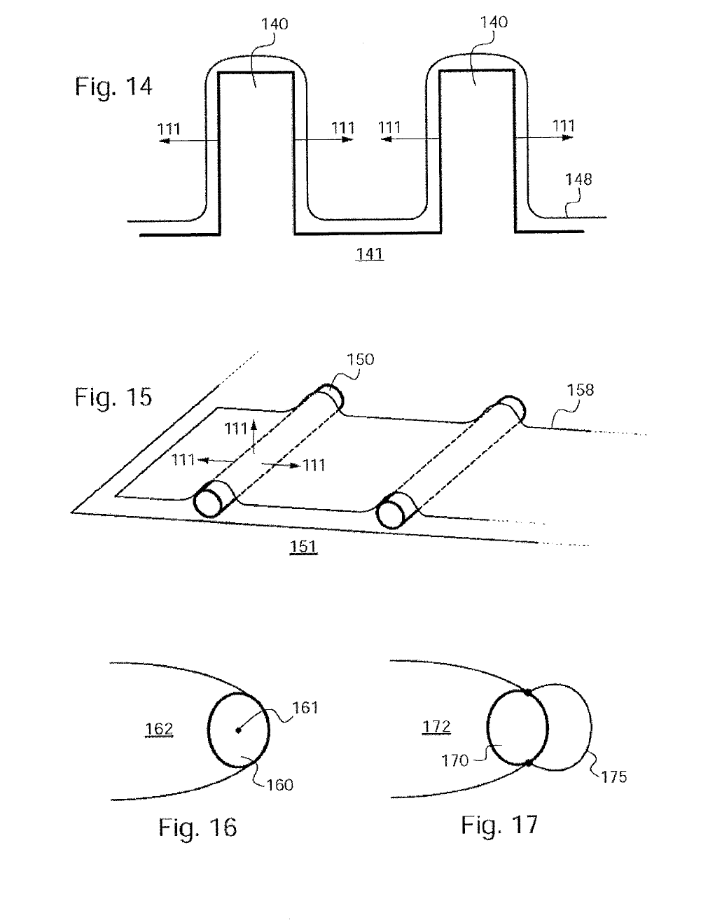

In another embodiment, with reference to FIGS. 14 and 15, SiC is deposited on a metallic substrate 141 or 151 bearing studs 140 with faces having a <111> crystal lattice geometry, or lengths of metallic or nonmetallic nanowires 150, for example of hexagonal section. This feature of the support makes it possible to obtain good curvature for the molecular sheet 148 or 158 of SiC once it is deposited on the surface. In FIG. 14, the tubes are formed in an upright fashion, whereas in FIG. 15 they are formed in a recumbent fashion.

Moreover, according to step E21, the reactivity of the terminations of the cages obtained is reduced, i.e. the part of the cage, formed with 1, 3 or 5 layers of atoms, which constitutes the free edges of the surface containing the bonds between the atoms. For this, the terminations are functionalized, which prevents the terminations coming close together and possibly reacting to form bonds.

In an embodiment, with reference to FIG. 16, this is done by adding adatoms (adsorbed atoms), for example of platinum 161, positioned near the termination 160 of the cage 162. In an alternative embodiment, polyatomic structures are grafted, such as organic or organometallic molecules, or metal clusters, in the gas phase, in the liquid phase by CVD or PVD (chemical vapour deposition or physical vapour deposition). These elements are added in order to create charge transfer between them and the cage. The terminations are then charged, positively or negatively, and cannot come close together, owing to electrostatic repulsion. Thus, stable cages are obtained, offering useful properties under exacting conditions.

In another embodiment, with reference to FIG. 17, a termination 170 of a cage 172 is forced to remain deformed. This operation is carried out by adding a molecule 175, bound chemically to the termination 170 of the cage, which prevents it from opening, acting as a spring, or in one variant as a flange. Accordingly, the edges of the cage remain deformed, their conformation is blocked and their reactivity is consequently reduced. Thus, stable cages are obtained, offering useful properties under exacting conditions.

As already mentioned, the functionalization, the formulation (choice of a solvent, of cosolutes, of a preservative or of a stabilizer) and the final presentation, for example in concentrated or dilute solution or in the gas phase, constitute a conditioning process of the nanometric structure.

This conditioning process, as well as the process of formation of the nanometric structure, is adapted in relation to the position of a linear dimension of the structure relative to a threshold value, as noted later with reference to FIGS. 12 and 13.

With reference to FIG. 6, this shows a nanometric cage 600 of silicon carbide resulting from cutting a nanotube (m, m), i.e. a nanotube of “armchair” configuration. The latter is shown after it has developed to minimize its energy.

It is to be noted that generally a nanotube is, according to the established notation, similar to a sheet of graphene wound around itself, said sheet of graphene being characterized by two direction vectors, a₁ and a₂. A vector Cₕ called chirality vector is perpendicular to the axis about which the graphene is rolled up to form the nanotube. The chirality vector is defined to within a modulo, the modulo being equal to the dimension of the wall in the direction orthogonal to the axis of the tube, and to the diameter of the tube. This vector is decomposed on the basis of the vectors a₁ and a₂ according to the equality Cₕ=n a₁+m a₂. When n=m the tube is of “armchair” configuration, when m=0 the tube is of “zigzag” configuration, and in all other configurations of the pair (n, m) it is called a chiral tube.

The cage 600 comprises 6 layers (numbered and indicated by arrows in FIG. 4) and has a diameter defined by m=5, m being, as was seen above, directly proportional to the diameter of the nanotube.

The structure, after cutting of the sheet, develops via formation of m squares and of a polygon with 2 m vertices on the cut edge of the nanotube. In FIG. 6, we see two decagons 610, the planes of which are represented by the symbol P at each end of the structure. There is folding of the end of the cylinder towards the interior of the cylinder. This folding is characterized by a curvature in the surface of the cage as the end is approached, and the formation of square structures of chemical bonds.

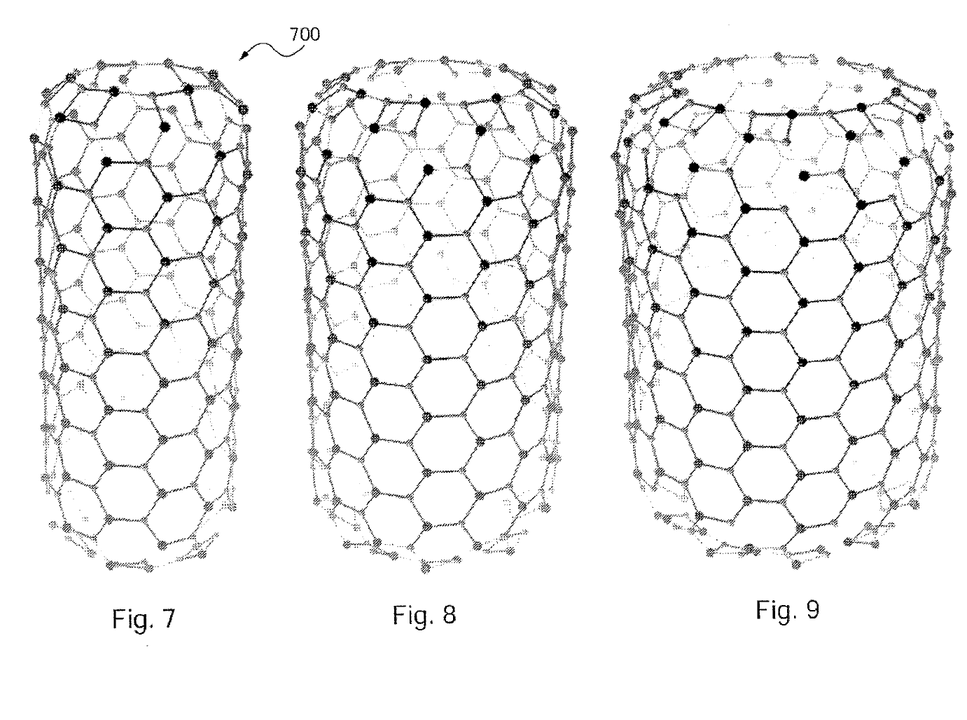

FIG. 7 shows a cage 700 of diameter m=6 and with c=18 layers (i.e. a structure with 216 atoms). This cage 700 resembles a SiC nanotube with deformation induced by a dodecagonal termination, where the curvature and stretching also affect some sections of the interior.

FIGS. 8 and 9 also show cages 800 and 900 with 18 layers of diameter m=8 and 10 respectively. Each of these representations is that of the conformation of the structure with minimum local energy and is therefore representative of a stable structure that is of industrial interest.

It is to be noted that the length of the cages obtained in this way with a diatomic material and armchair folding can be variable, with even numbers c of atomic layers perpendicular to the axis of the cylinder, at least equal to c=4, 6 or 8, and whose maximum value is determined solely by the nanometric character of the cage.

In FIGS. 6 to 9, the two terminations of the structure are identical. In FIG. 16, an adatom is present on one termination, and according to a variant, another identical adatom is present in the same way on the second termination. According to another variant, the second termination is the object of different grafting or is not the object of any grafting. According to a variant, the grafting of an adatom is characterized statistically for a large number of structures. In FIG. 17, a flange is present on a termination, and according to a variant, another identical flange is present in the same way on the second termination. According to another variant, the second termination is the object of a different stress or is not the object of any stress. According to a variant, the presence of flanges is characterized statistically for a large number of structures.

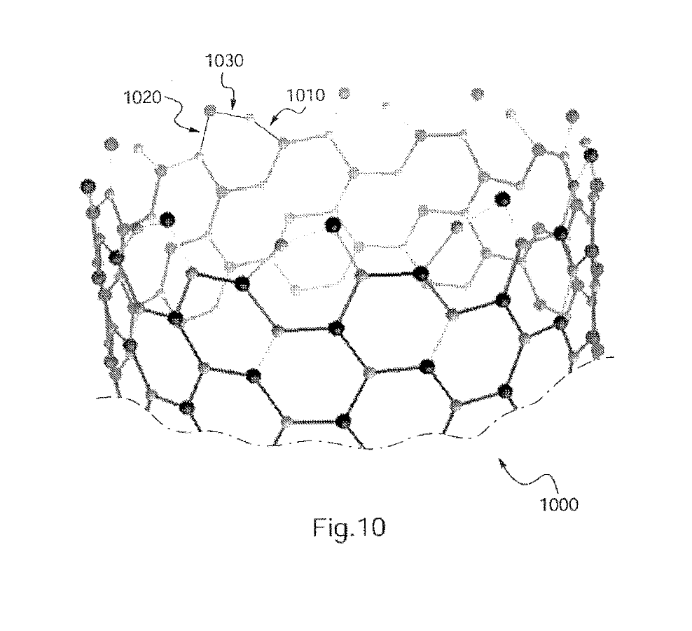

With reference to FIG. 10, development of the termination of a SiC nanotube 1000 can take place in another way. This second route is shown here, and involves dimerization of the pendant Si—C bonds 101 and 102, by formation of a bond 130 between the end-most atoms of these bonds. Only the upper end of the nanotube is shown in this partial figure.

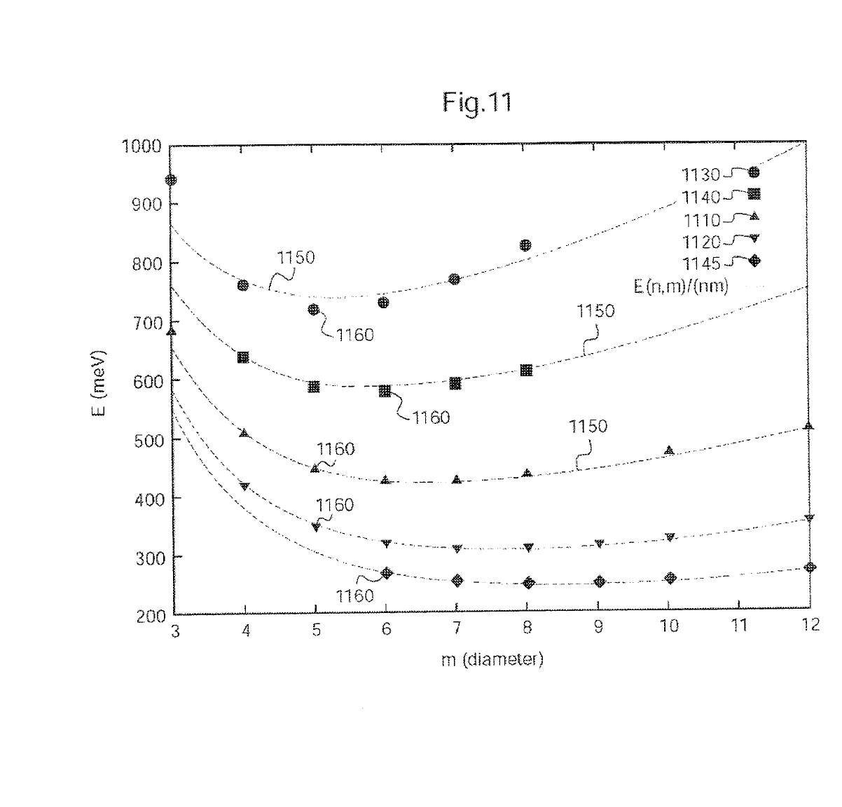

With reference to FIGS. 11 to 13, comparative analysis of the energy stability of different structures of stoichiometric silicon carbide (ratio of Si to C of 1:1) is carried out by means of density functional theory (DFT). The energy values of the structures relative to the number of pairs of Si—C atoms are shown on the ordinate. The reference energy is the energy per Si—C bond of a sheet of SiC. The parameter m, proportional to the diameter, is shown on the abscissa.

The DFT calculations are performed using the BigDFT software, available on the Internet. The number of base functions is selected in such a way that the results for energy per Si—C bond are accurate to within 1 meV. The geometries are considered optimized when the forces between two atoms are less than 0.1 mHa/bohr. The exchange and correlation function used is the PBE functional (J. Perdew, K. Burke and M. Ernzerhof, Phys. Rev. Lett. 77, 3865, 1996). The pseudopotentials are of the form HGH (Hartwigsen et al., Phys. Rev. B 58, 3641, 1998 and Genovese et al., J. Chem. Phys., 125, 074105, 2006), in the Krack variant (Krack, Theor. Chem. Acc., 114, 145, 2005). The calculations are performed at 0 K.

With reference to FIGS. 11 to 13, the energy of an armchair cage with c atomic layers perpendicular to the axis and with diameter m is expressed by the formula E (c, m)=(c−6) E_{b}(m)+2 Eₜ(m), where E_{b} is the energy of a slice in the interior of the structure (b for body) and Eₜ is the energy associated with a deformed end (t for termination), for which the thickness modelled is of three layers, which means that the thickness of the interior of the structure is c−6 layers.

The following analytical models are selected respectively for the energy associated with a deformed end and the energy of a slice from the interior: Eₜ(m)=Aₜm²+Cₜ and E_{b}(m)=A_{b}/m. This choice of model is explained for the first term Eₜ by the fact that the energy of an end comprises the contribution of the energies of the chemical bonds formed, the number of which is proportional to the diameter, conjugated with the energy cost of the curvature of the termination, which itself increases proportionally to the diameter. The conjugation is explained by the fact that the two effects are physically independent of one another. For the second term E_{b}, the choice of model is explained by the fact that the energy of a slice of a cylinder is proportional to its curvature, which itself is inversely proportional to the diameter.

The values of E_{b} and Eₜ are determined by analysing the energies of the cages at c=12 and 18 layers (referenced 1110 and 1120), for values of m between 4 and 12. The numerical values determined are: Aₜ=208.52, Cₜ=5888.37, A_{b}=3974.74 (in meV).

The model thus obtained has been validated with other structures, in particular those with 6, 8 and 24 layers (referenced 1130, 1140 and 1145). A correct optimum diameter is reproduced for each family, as shown by curves 1150 representing the function E (number of layers c, m), referred to the number of bonds of the structure investigated.

Then the energies of the terminations are analysed for these structures with c=6 and c=12, and the model Eₜ(m)=A′_{t m}+C′ₜ. This choice of model is justified by the fact that the energy of the termination in this form is proportional to the number of bonds formed, proportional to the circumference and therefore proportional to the diameter. We then get Aₜ=4064.81 and C′ₜ=1473.43 (meV).

For small diameters, the termination with squares and polygon (FIGS. 6 to 9) can be more favourable in energy terms than the termination following this second route (FIG. 10), whereas at a higher value of diameter the opposite is true.

With reference to FIG. 12, where the abscissa shows the value m proportional to the diameter, and the ordinate shows the energy Eₜ of the terminations of the structures with folding of the end (referenced 1210, similar to the structures in FIGS. 6 to 9) and of the structures without folding (referenced 1220, similar to the structure in FIG. 10), the energy of the structures having these terminations 2×1 is compared with those having the polygonal terminations. It can be seen that there is a critical radius 1230 for silicon carbide, one estimate for which is m₀=19 or 20, which is equivalent to a diameter of the order of 3.1 nanometres.

In addition, this comparison is made including, in the energy values, the energies of the cylindrical body for a given, constant number of layers of atoms. The values of m₀ obtained are consistent with those obtained for the terminations alone.

As a function of temperature, the value of m₀ varies by the order of a few % or some tens %, up to 20, 40, 60 or 80%.

With reference to FIG. 11, the value m proportional to the diameter is shown on the abscissa, and the total energy (including the factor Eₜ and the factor E_{b}) relative to the number of atoms of stoichiometric Si—C structures is shown on the ordinate.

When the diameter of the structure increases, the curvature of the main part of the tube (in particular the part away from the ends) decreases, and the local conformation becomes similar to that of the flat sheet of SiC, with development proportional to the reciprocal of the diameter, favouring cages of large diameter.

The decrease in total energy (including the factor Eₜ and the factor E_{b}) per SiC pair of the structure is moreover proportional to the length of the latter parallel to its axis.

This mechanism is in competition with the deformation of the folded end, which is increasingly energetically expensive as the diameter increases.

An optimum diameter, corresponding to a minimum energy per SiC pair, is reached when the stabilization induced by the decrease in curvature in the body counterbalances the deformation generated at the end (referenced 1160 in FIG. 11).

The following table presents the energy minima 1160 observed. We thus observe a relationship between the diameter and the length of the cages at minimum energy.

TABLE

| | | | | | |
|---|---|---|---|---|---|
| Number of | 6 | 8 | 12 | 18 | 24 |
| layers c | | | | | |
| m | 5 | 6 | 7 (close to 6) | 7 (close to 8) | 8 |
| Number of | 60 | 96 | 168 | 252 | 384 |
| atoms | | | | | |

Structures whose values of length and of diameter are only a little way away from the values corresponding to the minimum energy also have an energy close to the minimum of the curve shown in FIG. 11. It should be noted at this point that the characteristics connected with the technical effect of the relationship between diameter and length are advantageous, but not essential to the invention. For these cages the difference between their energy and the energy of the structure with minimum energy on the curve shown in FIG. 11 is preferably less than 50, 20, 10, 5, 1 or 0.1% of the difference between the energy of the minimum structure and the energy of the SiC graphene sheet, previously used as a reference.

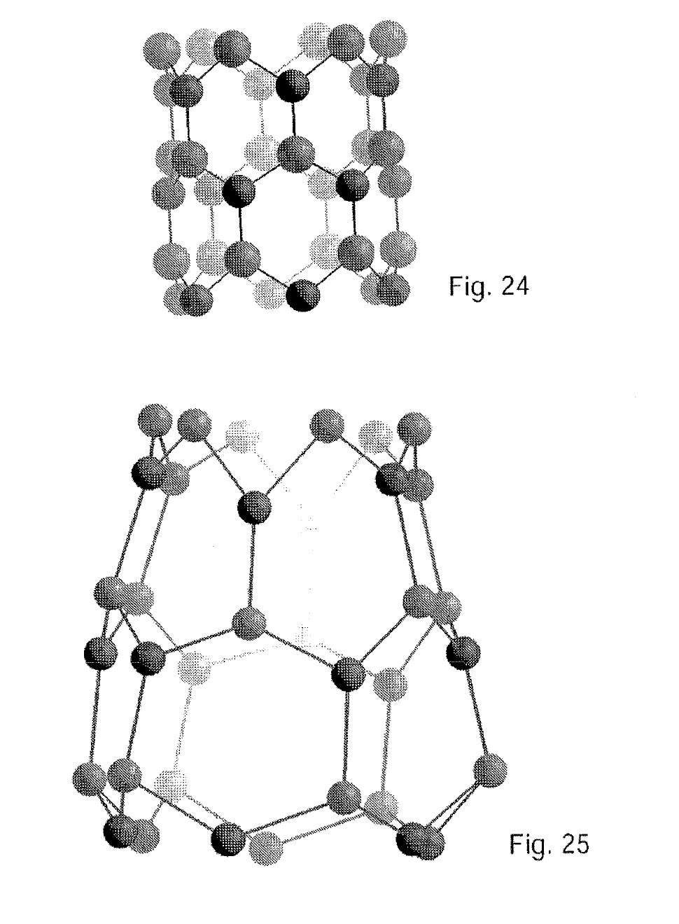

With reference to FIGS. 24 and 25, according to an alternative embodiment, the folding of the nanotube is zigzag. FIG. 24 shows a cage where the end has undergone constriction, and FIG. 25 shows a cage with unfolded ends. FIG. 24 shows folding of the end of the cylinder towards the interior of the cylinder. This folding is characterized by a curvature in the surface of the cage on approaching the end.

The energies of the structures in FIGS. 24 and 25 vary as a function of the diameter of the structure in such a way that there is a value of diameter for which the energies cross, thus defining two areas of values of diameter in which the conditioning of the structures is adapted differently.

According to an alternative embodiment, the material used is boron nitride BN, available in the form of nanotube or sheets. With reference to FIG. 13, the critical diameter 1330 is equal to m=9 or 10, i.e. about 1 nm. Nanotubes of boron nitride, for example multi-wall, or of graphitic boron nitride, are used as the basic material.

According to other embodiments, the material used is boron, aluminium nitride or gallium nitride, zinc oxide, or some other material able to form a molecular sheet. For example, boron available in the form of nanotubes is used.

The values of critical diameter (in nm) corresponding to m₀ are greater for gallium nitride and zinc oxide than those found for silicon carbide. A value of about 5 nm, i.e. m₀=29, is found for aluminium nitride.

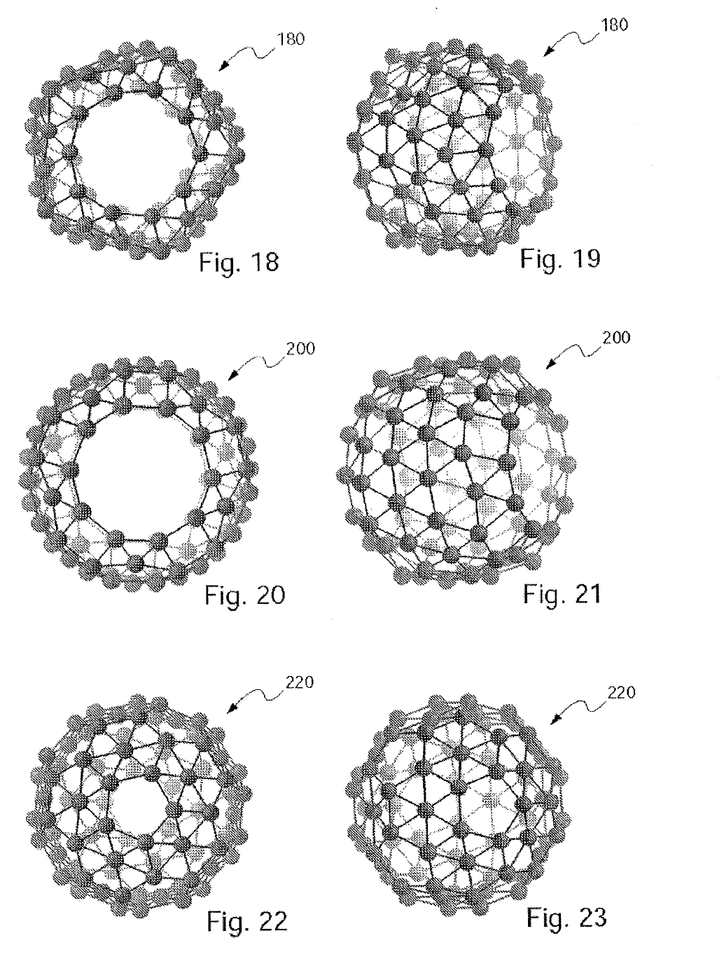

With reference to FIGS. 18 to 23, three structures of boron are shown, in side view (FIGS. 18, 20 and 22) and in top view (FIGS. 19, 21 and 23). The three cages each comprise 80 boron atoms. The cage 180 in FIGS. 18 and 19 is higher in energy than cage 200 in FIGS. 20 and 21, which is itself higher in energy than cage 220 in FIGS. 22 and 23.

Cage 180 comprises c=6 layers, and is of zigzag geometry.

Cage 200 comprises c=6 layers and is of armchair geometry. The number of vertices of the termination polygon can be even or odd.

Cages without folding or constriction (not shown) analogous to cages 180 and 200 constitute conformations with different energies, and there are values of diameter (one value for the zigzag family, one value for the armchair family) for which the energies cross, defining two areas of values of diameter in which the conditioning is adapted differently.

Cage 220 is analogous to a fullerene, comprises 12 pentagons, and constitutes an overall minimum.

Cages 180 and 200 are obtained by the process according to the invention using zigzag or armchair nanotubes, respectively. In the case of boron, thermal activation leads from cage 180 or from cage 200 to cage 220.

In general, the invention is applied to the physics, chemistry and biology of nanostructures, in mechanical, electronic, optical, catalytic or therapeutic functions. For silicon carbide, it is applied in particular in power electronics, heterogeneous catalysis, substrates for materials and electronics.

The invention is not limited to the embodiments described but includes all variants within the scope of a person skilled in the art.

1. Process for manufacturing a nanometric cage, comprising a step of formation and conditioning of an object whose general shape is that of a cylinder of revolution, wherein the conditioning of the object is adapted as a function of the position of the value of the diameter of the cylinder of revolution relative to a threshold below which folding of the ends of the cylinder is favoured in terms of a comparison of the energies of the object with folded ends and of the object with unfolded ends at 0 K, the threshold varying as a function of temperature.

2. The process according to claim 1, wherein the object comprises a nanotube.

3. The process according to the preceding claim, wherein the nanotube comprises an “armchair” configuration or a “zigzag” configuration, or a chiral configuration.

4. The process according to claim 2, wherein the nanotube comprises a single-wall nanotube.

5. The process according to claim 2, wherein the nanotube comprises a multi-wall nanotube with wide inter-wall spacing.

6. The process according to claim 1, wherein the object comprises a sheet.

7. The process according to claim 6, wherein the step of formation and conditioning comprises a step of deposition on a support using a mask in the form of rectangles or parallelograms.

8. The process according to claim 1, wherein the step of formation and conditioning comprises a step of cutting.

9. The process according to claim 8, wherein the cutting further comprises a step of ion bombardment.

10. The process according to claim 8, wherein the cutting further comprises a step of lithography.

11. The process according to claim 1, wherein the step of formation and conditioning further comprises a step of placement, on an edge of the object, of an element suitable for causing charge transfer with the cage.

12. The process according to claim 1, wherein the step of formation and conditioning further comprises a step of grafting, on an edge of the object, of an element suitable for constraining said edge geometrically.

13. The process according to claim 12, wherein the element is suitable for constraining the edge geometrically is comprises a flange.

14. The process according to claim 1, wherein the step of formation and conditioning is such that the object has a ratio of diameter to length that minimizes the energy per atom of the structure in terms of comparison of the energies of the structures at 0 K.

15. The process according to claim 1, wherein the object comprises silicon carbide, boron nitride, gallium nitride, aluminium nitride, zinc oxide or boron.

16. The process according to claim 15, wherein the object comprises stoichiometric or near-stoichiometric silicon carbide or stoichiometric or near-stoichiometric boron nitride.

17. The process according to claim 16, wherein the cylinder comprises an “armchair” configuration.

18. The process according to claim 1, wherein the object comprises boron used directly in nanotube form.

19. A nanometric cage FIG., comprising an object whose general shape is that of a cylinder of revolution, and conditioning of which is adapted as a function of a position of the value of the diameter of the cylinder of revolution relative to a threshold below which folding of ends of the cylinder is favoured in terms of a comparison of the energies of the object with folded ends and of the object with unfolded ends at 0 K, the threshold varying as a function of temperature.

20. The nanometric cage FIG. according to claim 19, the cylinder of revolution having a diameter below the threshold.

21. The nanometric cage FIG. according to claim 19, the cylinder of revolution having a diameter above the threshold.

22. The nanometric cage according to claim 19, wherein the folding is zigzag, armchair or chiral.

23. The nanometric cage according to claim 19, wherein the ends are identical.

24. The nanometric cage according to claim 19, the cylinder of revolution having a ratio of diameter to length that minimizes the energy per atom of the object in terms of comparison of the energies of objects of ientical lengths and of variable diameters at 0 K.

25. The nanometric cage according to claim 19, wherein a material of composition comprises silicon carbide, boron nitride, gallium nitride, aluminium nitride, zinc oxide or boron.

26. The nanometric cage according to claim 25, the material comprising stoichiometric or near-stoichiometric silicon carbide or boron nitride.

27. The nanometric cage according to claim 20, comprising, on an edge of the object, an element suitable for causing charge transfer with the cage.

28. The nanometric cage according to claim 20, comprising, on an edge of the object, a grafted element suitable for constraining said edge geometrically.

29. An element of molecular sheet suitable for forming, optionally via topological folding, an object whose general shape is that of a cylinder of revolution having a diameter below a threshold below which folding of the ends of the cylinder is favoured in terms of a comparison of the energies of the object with folded ends and of the object with unfolded ends at 0 K, the threshold varying as a function of temperature.

30. A cage obtained by the process of claim 1.
